(19) United States
(12) Patent Application Publication
(10) Pub. No.: US 2017/0220951 A1
(43) Pub. Date: Aug. 3, 2017

(54) ADAPTING MULTIPLE SOURCE CLASSIFIERS IN A TARGET DOMAIN

(71) Applicant: Xerox Corporation, Norwalk, CT (US)

(72) Inventors: Boris Chidlovskii, Meylan (FR); Gabriela Csurka, Crolles (FR); Stéphane Clinchant, Grenoble (FR)

(73) Assignee: Xerox Corporation, Norwalk, CT (US)

(21) Appl. No.: 15/013,401

(22) Filed: Feb. 2, 2016

(51) Int. Cl. G06N 99/00; G06F 17/27

(52) U.S. Cl. CPC G06N 99/005; G06F 17/2705

(57) ABSTRACT

Training instances from a target domain are represented by feature vectors storing values for a set of features, and are labeled by labels from a set of labels. Both a noise marginalizing transform and a weighting of one or more source domain classifiers are simultaneously learned by minimizing the expectation of a loss function that is dependent on the feature vectors corrupted with noise represented by a noise probability density function, the labels, and the one or more source domain classifiers operating on the feature vectors corrupted with the noise. An input instance from the target domain is labeled with a label from the set of labels by operations including applying the learned noise marginalizing transform to an input feature vector representing the input instance and applying the one or more source domain classifiers weighted by the learned weighting to the input feature vector representing the input instance.

### BACKGROUND

The following relates to the machine learning arts, classification arts, surveillance camera arts, document processing arts, and related arts.

Domain adaptation leverages labeled data in one or more related source domains to learn a classifier for unlabeled data in a target domain. Domain adaptation is useful where a new classifier is to be trained to perform a task in a target domain for which there is limited labeled data, but where there is a wealth of labeled data for the same task in some other domain. One illustrative task that can benefit from domain adaptation is document classification. For example, it may be desired to train a new classifier to perform classification of documents for a newly acquired corpus of text-based documents (where “text-based” denotes the documents comprise sufficient text to make textual analysis useful). The desired classifier receives as input a feature vector representation of the document, for example a “bag-of-words” feature vector, and the classifier output is a semantic document label. In training this document classifier, substantial information may be available in the form of previously labeled documents from one or more previously available corpora for which the equivalent classification task has been performed (e.g. using other classifiers and/or manually). In this task, the newly acquired corpus is the “target domain”, and the previously available corpora are “source domains”. Leveraging source domain data in training a classifier for the target domain is complicated by the possibility that the source corpora may be materially different from the target corpus, e.g. using different vocabulary and/or directed to different semantic topics (in a statistical sense).

Another illustrative task that can benefit from domain adaptation is object recognition performed on images acquired by surveillance cameras at different locations. For example, consider a traffic surveillance camera newly installed at a traffic intersection, which is to identify vehicles running a traffic light governing the intersection. The object recognition task is thus to identify the combination of a red light and a vehicle imaged illegally driving through this red light. In training an image classifier to perform this task, substantial information may be available in the form of labeled images acquired by red light enforcement cameras previously installed at other traffic intersections. In this case, images acquired by the newly installed camera are the “target domain” and images acquired by red light enforcement cameras previously installed at other traffic intersections are the “source domains”. Again, leveraging source domain data in training a classifier for the target domain is complicated by the possibility that the source corpora may be materially different from the target corpus, e.g. having different backgrounds, camera-to-intersection distances, poses, view angles, and/or so forth.

These are merely illustrative tasks. More generally, any machine learning task that seeks to learn a classifier for a target domain having limited or no labeled training instances, but for which one or more similar source domains exist with labeled training instances for the same task, can benefit from performing domain adaptation to leverage these source domain(s) data in learning the classifier to perform the task in the target domain.

Various domain adaptation techniques are known for leveraging labeled instances in one or more source domains to improve training of a classifier for performing the same task in a different target domain for which the quantity of available labeled instances is limited. For example, stacked marginalized denoising autoencoders (mSDAs) are a known domain adaptation approach. See Chen et al., “Marginalized denoising autoencoders for domain adaptation”, ICML (2014); Xu et al., “From sBoW to dCoT marginalized encoders for text representation”, in CIKM, pages 1879-84 (ACM, 2012). Each mSDA iteration corrupts features of the feature vectors representing the training instances and trains a DA to map back to remove the noise. Repeated iterations thereby generate a stack of DA-based transform layers operative to transform the source and target domains to a common adapted domain.

Another known domain adaptation technique is known as the marginalized corrupted features (MCF) technique. See van der Maaten et al., “Learning with marginalized corrupted features”, in Proceedings of the 30th International Conference on Machine Learning, ICML 2013, Atlanta, Ga., USA, 16-21 Jun. 2013, pages 410-418 (2013). The MCF domain adaptation method corrupts training examples with noise from known distributions and trains robust predictors by minimizing the statistical expectation of the loss function under the corrupting distribution. MCF classifiers can be trained efficiently as they do not require explicitly introducing the noise to the training instances. Instead, MCF takes the limiting case of many corruption iterations, in which case the distribution of noise in the corrupted data assumes the noise probability density function (noise pdf).

### BRIEF DESCRIPTION

In some embodiments disclosed herein, a computer is programmed to perform a machine learning method operating on training instances from a target domain. The training instances are represented by feature vectors storing values for a set of features and labeled by labels from a set of labels. The machine learning method includes the operation of optimizing a loss function to simultaneously learn both a noise marginalizing transform and a weighting of the one or more source domain classifiers. The loss function is dependent on all of: (1) the feature vectors representing the training instances from the target domain corrupted with noise; (2) the labels of the training instances from the target domain; and (3) one or more source domain classifiers operating on the feature vectors representing the training instances from the target domain corrupted with the noise. The machine learning method includes the further operation of generating a label prediction for an unlabeled input instance from the target domain that is represented by an input feature vector storing values for the set of features by operations including applying the learned noise marginalizing transform to the input feature vector and applying the one or more source domain classifiers weighted by the learned weighting to the input feature vector. In some embodiments the loss function is not dependent on any training instance from any domain other than the target domain.

In some embodiments disclosed herein, a non-transitory storage medium stores instructions executable by a computer to perform a machine learning method operating on N training instances from a target domain. The training instances are represented by feature vectors xₙ, n=1, . . . , N storing values for a set of features, and are labeled by labels yₙ, n=1, . . . , N from a set of labels. The machine learning method including the operation of optimizing the function [symbol] (w,z) given by:

$$ℒ ( w , z ) = {\sum }_{n = 1}^{N} {𝔼 [ L ( {\tilde{x}}_{n} , f , {y}_{n} ; w , z ) ]}_{p ( {\tilde{x}}_{n} \vert {x}_{n} )}$$

with respect to w and z where \tilde{x}ₙ, n=1, . . . , N are the feature vectors representing the training instances from the target domain corrupted with noise, p(\tilde{x}ₙ|xₙ) is a noise probability density function (noise pdf) representing the noise, f represents one or more source domain classifiers, L is a loss function, w represents parameters of a noise marginalizing transform, z represents a weighting of the one or more source domain classifiers, and [symbol] is the statistical expectation, to generate learned parameters w* of the noise marginalizing transform and a learned weighting z* of the one or more source domain classifiers. The machine learning method including the further operation of generating a label prediction ŷᵢₙ for an unlabeled input instance from the target domain represented by input feature vector xᵢₙ by operations including applying the noise marginalizing transform with the learned parameters w* to the input feature vector xᵢₙ and applying the one or more source domain classifiers weighted by the learned weighting z* to the input feature vector xᵢₙ.

In some embodiments disclosed herein, a machine learning method is disclosed, which operates on training instances from a target domain. The training instances are represented by feature vectors storing values for a set of features, and are labeled by labels from a set of labels. The machine learning method comprises: simultaneously learning both a noise marginalizing transform and a weighting of one or more source domain classifiers by minimizing the expectation of a loss function dependent on the feature vectors corrupted with noise represented by a noise probability density function, the labels, and the one or more source domain classifiers operating on the feature vectors corrupted with the noise; and labeling an unlabeled input instance from the target domain with a label from the set of labels by operations including applying the learned noise marginalizing transform to an input feature vector representing the unlabeled input instance and applying the one or more source domain classifiers weighted by the learned weighting to the input feature vector representing the unlabeled input instance. The simultaneous learning and the labeling are suitably performed by a computer.

### BRIEF DESCRIPTION OF THE DRAWINGS

FIG. 1 diagrammatically illustrates a machine learning device for learning a classifier in a target domain including domain adaptation as disclosed herein to leverage trained classifiers for one or more other (source) domains, and for using the trained target domain classifier.

FIGS. 2, 3, 4A, 4B, 4C, 5A, 5B, 5C, 6A, 6B, 6C, 7A, 7B, and 7C present experimental results as described herein.

### DETAILED DESCRIPTION

Domain adaptation techniques entail adapting source domain data to the target domain, or adapting both source and target domain data to a common adapted domain. Domain adaptation approaches such as mSDA and MCF rely upon the availability of a wealth of labeled source domain data that exceeds the available labeled target domain data, so that the domain adaptation materially improves training of the target domain classifier as compared with training on the limited target domain data alone.

In practice, however, the available quantity of labeled source domain data may be low, or even nonexistent. In some applications the source domain data are protected by privacy laws, and/or are confidential information held in secrecy by a company or other data owner. In other cases, the source domain data may have been available at one time, but has since been discarded. For example, in traffic surveillance camera training, the training images acquired to train existing camera installations may be retained only for a limited time period, e.g. in accordance with a governing data retention policy or discarded under pressure to free up data storage space.

Disclosed herein are approaches for performing domain adaptation when the source domain is represented by a source domain classifier, rather than by labeled source domain data.

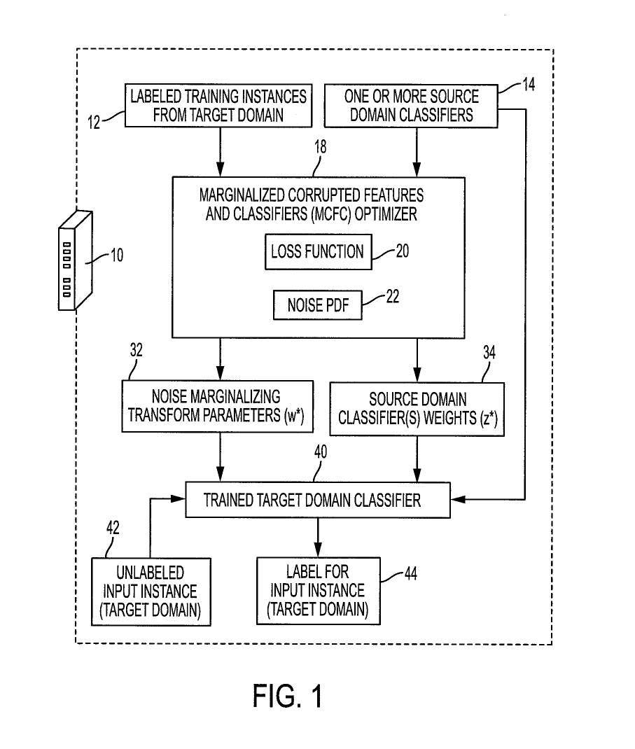

With reference to FIG. 1, a machine learning device includes a computer 10 programmed to learn and apply a classifier in a target domain. The computer 10 may, for example, be an Internet-based server computer, a desktop or notebook computer, an electronic data processing device controlling and processing images acquired by a roadside surveillance camera, or so forth. The disclosed machine learning techniques may additionally or alternatively be implemented in the form of a non-transitory storage medium storing instructions suitable for programming the computer 10 to perform the disclosed classifier training and/or inference functions. The non-transitory storage medium may, for example, be a hard disk drive or other magnetic storage medium, an optical disk or other optical storage medium, a solid state disk, flash drive, or other electronic storage medium, various combination(s) thereof, or so forth. While a single computer 10 is illustrated in FIG. 1 as both training the classifier (learning phase) and using the classifier (inference phase), in other embodiments different computers may perform the learning phase and the inference phase. For example, the learning phase, which is usually more computationally intensive, may be performed by a suitably programmed network server computer, while the less computationally intensive inference phase may be performed by an electronic data processing device (i.e. computer) of a roadside traffic camera system.

The classifier learning receives two inputs: a set of (without loss of generality N) labeled training instances 12 drawn from the target domain, and one or more source domain classifiers 14. The N labeled training instances 12 are represented by feature vectors xₙ, n=1, . . . , N storing values for a set of features, and are labeled by labels yₙ, n=1, . . . , N from a set of labels. The one or more source domain classifiers 14 were each trained to perform materially the same task as the classifier to be trained, but each source domain classifier was trained on training instances drawn from a source domain (which is different from the target domain).

These inputs 12, 14 are input to a training system, referred to herein as a marginalized corrupted features and classifiers (MCFC) optimizer 18, which optimizes a loss function 20 dependent on all of the following. First, the loss function 20 is dependent on the feature vectors representing the training instances 12 from the target domain corrupted with noise. The noise is preferably, although not necessarily, represented by a noise probability density function (noise pdf) 22. The loss function 20 also receives as input the labels of the training instances 12 from the target domain. In addition to being dependent on this target domain training data, the loss function 20 is further dependent on the one or more source domain classifiers 14 operating on the feature vectors representing the training instances 20 from the target domain corrupted with the noise 22. The optimization of the loss function 20 simultaneously learns both a noise marginalizing transform (or, more particularly, parameters 32 of the noise marginalizing transform) and a weighting 34 of the one or more source domain classifiers.

It will be noted that in the embodiment of FIG. 1, the MCFC optimizer 18 does not receive, and the loss function 20 is not dependent on, any training instance from any domain other than the target domain. In other words, the loss function depends on the labeled training instances 12 from the target domain, but does not depend on any labeled training instances from any source domain. Rather, the one or more source domains used in the domain adaptation are represented solely by the one or more source domain classifiers 14. It follows that the MCFC optimizer can be used to train a classifier to perform a task in the target domain using domain adaptation even if no relevant training instances are actually available from any source domain. Thus, for example, the MCFC optimizer 18 can be used to train a new traffic camera to perform a traffic enforcement task using domain adaptation leveraging only classifiers of other traffic camera installations, even if the source training data used to train those other traffic camera installations is no longer available, or is not available to the entity training the new traffic camera.

In some illustrative embodiments, the loss function (denoted herein as L) is optimized by optimizing its statistical expectation over the N target domain training instances 12 according to [symbol] (w,z)=Σₙ₌₁^{N} [symbol] [L(\tilde{x}ₙ, f, yₙ; w, z)]_{p(\tilde{x}}_{ₙ}_{|x}_{ₙ}₎ where xₙ, n=1, . . . , N are the feature vectors representing the training instances 12 from the target domain, \tilde{x}ₙ, n=1, . . . , N are the feature vectors representing the training instances from the target domain corrupted with the noise, P(\tilde{x}ₙ|xₙ) is the noise pdf 22 representing the noise, f represents the one or more source domain classifiers 14, w represents parameters 32 of the noise marginalizing transform, z represents the weighting 34 of the one or more source domain classifiers 14, and [symbol] is the statistical expectation. The learned parameters 32 of the noise marginalizing transform are denoted herein as w* and the learned weighting for the one or more source domain classifiers 14 is denoted herein as z*, where the superscript “*” denotes the optimized values obtained by optimizing the statistical expectation of the loss function over the N target domain training instances.

With continuing reference to FIG. 1, the learned noise marginalizing transform (represented by its learned parameters w* shown as block 32 in FIG. 1) and the learned weighting z* shown as block 34 in FIG. 1, are the parameters defining the learned target domain classifier 40. This classifier 40 receives an unlabeled input instance 42 in the target domain, represented by a feature vector xᵢₙ of the same form as the feature vectors xₙ, n=1, . . . , N representing the training instances 12. The classifier 40 operates on the input feature vector xᵢₙ to generate (i.e. predict) a label 44 for the input instance 42. Using the notation of the immediately preceding learning example, the classifier 40 may generating the label prediction 44, denoted as ŷᵢₙ, by operations including applying the noise marginalizing transform with the learned parameters w* to the input feature vector xᵢₙ and applying the one or more source domain classifiers 14 weighted by the learned weighting z* to the input feature vector xᵢₙ.

In embodiments in which the learning and inference phases are implemented on separate computers, the MCFC optimizer 18 is suitably implemented on a first (learning) computer, and the resulting noise marginalizing transform parameters 32 and classifier weighting 34 are output and transferred (via the Internet, or using a physical medium such as a thumb drive) to a second (inference) computer which implements the trained target domain classifier 40 using the learned parameters 32 and weighting 34.

Having provided with reference to FIG. 1 an overview of a device implementing machine learning of a classifier for performing a task in the target domain using domain adaptation by the disclosed MCFC technique, some quantitative examples are next set forth. In various such examples, it will be shown that for appropriate selection of the loss function 20, noise pdf 22, and/or source domain classifier(s) 14, the MCFC optimization can be implemented analytically in closed form, thus significantly improving computational efficiency.

In the following examples, the following notation is employed. Feature vectors exist in a features space X⊂R^{D}, that is, each feature vector is of dimensionality D. The possible labels form a label space y. A classifier is then defined by a function h:X→y. The number of domains is m+1 domains, including m source domains Sⱼ, j=1 . . . , m and a target domain T. The target domain training instances 12 are denoted as ((x₁;y₁), . . . , (xₙ_{_{T}};yₙ_{_{T}})), xᵢεX; yᵢεy, where xᵢ is the feature vector representing the i^{th} training instance and yᵢ is the label of the i^{th} training instance. From a source domain Sⱼ a classifier fⱼ of the classifiers 14 is assumed to have been trained on a source dataset (which may no longer be available). (This implicitly assumes the one or more classifiers 14 consist of m classifiers, one per source domain, but this is not necessary, e.g. the one or more source domain classifiers 14 could include two or more classifiers trained in a single domain, e.g. using different classifier architectures and/or different source domain training sets). The domain adaptation goal is to learn a classifier h_{T}:X→y with the help of the one or more source domain classifiers 14 denoted for these illustrative examples as f=, [f₁, . . . , fₘ] and the set of target domain training instances 12 to accurately predict the labels 44 of input instances 42 from the target domain T.

The illustrative MFCF optimizer 18 employs an approach similar to the marginalized corrupted features (MCF) technique; however, unlike in MCF in the MFCF technique no labeled source domain data are available. Rather, in the MFCF technique the one or more source domains are represented by one or more source domain classifiers 14. The corrupting distribution (e.g. noise pdf 22) is defined to transform observations x into corrupted versions denoted herein as \tilde{x}. In the following, it is assumed that the corrupting noise pdf factorizes over all feature dimensions and that each “per-dimension” distribution is a member of the natural exponential family, P(\tilde{x}|)=Π_{d=1}^{D}P_{E}(\tilde{x}_{d}|x_{d};θ_{d}), where x=(x₁, . . . , x_{D}) and θ_{d}, d=1, . . . , D is a parameter of the corrupting distribution on dimension d. The corrupting distribution can be unbiased (defined as [symbol] [\tilde{x}]_{p(\tilde{x}|x)}=x) or biased. Some illustrative examples of distribution P (also referred to herein as the noise pdf, e.g. noise pdf 22) are the blankout noise, Gaussian noise, Laplace noise, and Poisson noise. See, e.g. van der Maaten et al., “Learning with marginalized corrupted features”, in Proceedings of the 30th International Conference on Machine Learning, ICML 2013, Atlanta, Ga., USA, 16-21 Jun. 2013, pages 410-418 (2013). Three illustrative options for the noise pdf 22 are presented in Table 1.

TABLE 1
Illustrative noise pdf with statistical expectation and variance

| | | Expectation | Variance |
|---|---|---|---|
| Distribution | Noise pdf | [symbol] [\tilde{x}_{nd}] | Var[\tilde{x}_{nd}] |
| Blankout noise, unbiased | $\begin{matrix}p ( \tilde{x} = 0 ) = q \\ p ( \tilde{x} = \frac{x}{1 - q} ) = 1 - q\end{matrix}$ | x | $\frac{q}{1 - q} {x}^{2}$ |
| Blankout noise, | p(\tilde{x}_{nd} = 0) = q_{d} | (1 − q_{d})x_{nd} | q_{d}(1 − q_{d})x_{nd}² |
| Biased | p(\tilde{x}_{nd} = x_{nd}) = 1 − q_{d} | | |
| Gaussian noise, | p(\tilde{x}_{nd}\|x_{nd}) = | x_{nd} | σ² |
| unbiased | [symbol] (\tilde{x}_{nd}\|x_{nd}, σ²) | | |

The direct approach for introducing the noise is to select each element of the target training set D_{T}={(xₙ,yₙ)}ₙ₌₁^{N} and corrupt it M times. For each xₙ, this results in M corrupted observations \tilde{X}ₙₘ, m=1, . . . , M thus generating a new corrupted dataset of size M×N. This approach is referred to as “explicit” corruption. The explicitly corrupted data set can be used for training by minimizing

$$ℒ ( w , z ) = {\sum }_{n = 1}^{N} \frac{1}{M} {\sum }_{m = 1}^{M} L ( {\tilde{x}}_{nm} , f , {y}_{n} ; w , z ) \qquad ( 1 )$$

where \tilde{x}ₙₘ˜P(\tilde{x}ₙₘ|xₙ), w represents parameters of the noise marginalizing transform, z represents the weighting of the one or more source domain classifiers, L is a loss function of the model, f=[f₁(\tilde{x}ₙₘ), . . . , f_{M}(\tilde{x}ₙₘ)] is the vector of source classifier predictions for the corrupted instances \tilde{x}ₙₘ.

The explicit corruption in Equation (1) comes at a high computational cost, as the minimization of the loss function L scales up linearly with the number of corrupted observations, that is, with M×N. Following an approach analogous to that taken with MCF (see van der Maaten et al., supra), by taking the limiting case in which M→∞, the weak law of large numbers can be applied to and rewrite the inner scaled summation

$$\frac{1}{M} {\sum }_{m = 1}^{M} L ( {\tilde{x}}_{m} , f , {y}_{n} ; w , z )$$

as its expectation as follows:

$$ℒ ( w , z ) = {\sum }_{n = 1}^{N} {𝔼 [ L ( {\tilde{x}}_{n} , f , {y}_{n} ; w , z ) ]}_{p ( {\tilde{x}}_{n} \vert {x}_{n} )} \qquad ( 2 )$$

where [symbol] is the statistical expectation, using noise pdf p(\tilde{x}ₙ|xₙ). As the noise pdf is assumed to factorize over all feature dimensions, the corrupting distribution p(\tilde{x}ₙ|xₙ) can be applied as P(\tilde{x}_{nd}|x_{nd}) along each dimension d.

Minimizing [symbol] (w,z) in Equation (2) under the corruption model p(\tilde{x}ₙ|xₙ) provides the learned parameters w* of the noise marginalizing transform (block 32 of FIG. 1) and the learned weightings z* for the one or more classifiers 14 (block 34 of FIG. 1). Tractability of the minimization of Equation (2) depends on the choice of the loss function L and the corrupting distribution p(\tilde{x}ₙ|xₙ). In the following, it is shown that for linear classifiers and a quadratic or exponential loss function L, the required expectations under p(\tilde{x}ₙ|xₙ) can be computed analytically for different corrupting distributions.

A quadratic loss function is first considered. To start, by ignoring the domain adaptation component embodied by the one or more classifiers 14, the expectation of the quadratic loss under noise pdf p(\tilde{x}ₙ|xₙ) can be written as:

$$ℒ ( w ) = \frac{1}{N} {\sum }_{n = 1}^{N} {𝔼 [ {( {w}^{T} {\tilde{x}}_{n} - {y}_{n} )}^{2} ]}_{p ( {\tilde{x}}_{n} \vert {x}_{n} )} \qquad ( 3 )$$

As the quadratic loss is convex under any noise pdf, the optimal solution for w* can be written in closed form as (see van der Maaten et al., supra):

$${w}^{*} = {( {\sum }_{n = 1}^{N} 𝔼 [ {\tilde{x}}_{n} ] {𝔼 [ {\tilde{x}}_{n} ]}^{T} + diag ( Var [ {\tilde{x}}_{n} ] ) )}^{- 1} ( {\sum }_{n = 1}^{N} {y}_{n} 𝔼 [ {\tilde{x}}_{n} ] ) \qquad ( 4 )$$

when expectation [symbol] [\tilde{x}ₙ] is under p(\tilde{x}ₙ|xₙ) and the variance Var[\tilde{x}ₙ] is a diagonal D×D matrix of x. For any of the noise pdfs of Table 1, it is sufficient to substitute the values for expectation and variance from Table 1.

In the MCFC disclosed herein, domain adaptation cannot be done in this manner because there are (assumed to be) no available source domain training instances available. Rather, the one or more source domains are represented by the one or more classifiers 14. For this problem, a corresponding expectation of the quadratic loss under noise pdf p(\tilde{x}ₙ|xₙ) can be written as:

$$ℒ ( w , z ) = \frac{1}{N} {\sum }_{n = 1}^{N} {𝔼 [ {( {w}^{T} {\tilde{x}}_{n} + {z}^{T} f ( {\tilde{x}}_{n} ) - {y}_{n} )}^{2} ]}_{p ( {\tilde{x}}_{n} \vert {x}_{n} )} \qquad ( 5 )$$

This can be written in more explicit matrix form as:

$$ℒ ( w , z ) = \frac{1}{N} {\sum }_{n = 1}^{N} {𝔼 [ {( \begin{matrix}{{[ \begin{matrix}w \\ z\end{matrix} ]}^{T} [ \begin{matrix}{\tilde{x}}_{n} \\ f ( {\tilde{x}}_{n} )\end{matrix} ] [ \begin{matrix}{\tilde{x}}_{n} \\ f ( {\tilde{x}}_{n} )\end{matrix} ]}^{T} [ \begin{matrix}w \\ z\end{matrix} ] - \\ 2 {{y}_{n} [ \begin{matrix}w \\ z\end{matrix} ] [ \begin{matrix}{\tilde{x}}_{n} \\ f ( {\tilde{x}}_{n} )\end{matrix} ]}^{T} + {y}_{n}^{2}\end{matrix} )}^{2} ]}_{p ( {\tilde{x}}_{n} \vert {x}_{n} )} \qquad ( 5 a )$$

which can be further rewritten as:

$$ℒ ( w , z ) = {[ \begin{matrix}w \\ z\end{matrix} ]}^{T} \frac{1}{N} {\sum }_{n = 1}^{N} ( 𝔼 [ \begin{matrix}{\tilde{x}}_{n} \\ f ( {\tilde{x}}_{n} )\end{matrix} ] {𝔼 [ \begin{matrix}{\tilde{x}}_{n} \\ f ( {\tilde{x}}_{n} )\end{matrix} ]}^{T} + diag ( Var [ \begin{matrix}{\tilde{x}}_{n} \\ f ( {\tilde{x}}_{n} )\end{matrix} ] ) ) [ \begin{matrix}w \\ z\end{matrix} ] - 2 ( \frac{1}{N} {\sum }_{n = 1}^{N} {y}_{n} {𝔼 [ \begin{matrix}{\tilde{x}}_{n} \\ f ( {\tilde{x}}_{n} )\end{matrix} ]}^{T} ) [ \begin{matrix}w \\ z\end{matrix} ] + 1 \qquad ( 5 b )$$

If the one or more source domain classifiers 14 are linear classifiers, then the optimal solution can be shown to be:

$$[ \begin{matrix}{w}^{*} \\ {z}^{*}\end{matrix} ] = {\sum }_{n = 1}^{N} 𝔼 [ \begin{matrix}{\tilde{x}}_{n} \\ f ( {\tilde{x}}_{n} )\end{matrix} ] {𝔼 [ \begin{matrix}{\tilde{x}}_{n} \\ f ( {\tilde{x}}_{n} )\end{matrix} ]}^{T} + {diag ( Var [ \begin{matrix}{\tilde{x}}_{n} \\ f ( {\tilde{x}}_{n} )\end{matrix} ] )}^{- 1} ( {\sum }_{n = 1}^{N} [ \begin{matrix}{\tilde{x}}_{n} \\ f ( {\tilde{x}}_{n} )\end{matrix} ] ) \qquad ( 6 )$$

To summarize, to minimize the expected quadratic loss under the corruption model p(\tilde{x}ₙ|xₙ), the variance of the corrupting distribution is computed. This computation is practical for all exponential-family distributions, e.g. such as those of Table 1. The mean is always x_{nd} for unbiased noise pdfs.

As a further example, the combination of a quadratic loss L and the Gaussian noise pdf of Table 1 is considered, for which the mean is x and the variance is σ²I. For this case:

$$[ \begin{matrix}{w}^{*} \\ {z}^{*}\end{matrix} ] = {( {\sum }_{n = 1}^{N} {\hat{x}}_{n} {\hat{x}}_{n}^{T} + {σ}^{2} I ( {\hat{x}}_{n} ) )}^{- 1} ( {\sum }_{n = 1}^{N} {y}_{n} {\hat{x}}_{n} ) \qquad ( 7 )$$

where:

$${\hat{x}}_{n} = [ \begin{matrix}{x}_{n} \\ f ( {x}_{n} )\end{matrix} ] \qquad ( 8 )$$

As another example, an exponential loss function L is considered. In this case, the expected value under the corruption model p(\tilde{x}|x) is the following:

$$L ( w , z ) = {\sum }_{n = 1}^{N} {𝔼 [ {e}^{- {y}_{n} ( {w}^{T} {\tilde{x}}_{n} + {z}^{T} f ( {\tilde{x}}_{n} ) )} ]}_{p ( {\tilde{x}}_{n} \vert {x}_{n} )} \qquad ( 9 )$$

which can be rewritten as:

$$L ( w , z ) = {\sum }_{n = 1}^{N} {\prod }_{d = 1}^{D} {𝔼 [ {e}^{- {y}_{n} {w}_{d} {\tilde{x}}_{nd}} ]}_{p ( {\tilde{x}}_{n} \vert {x}_{n} )} {\prod }_{s = 1}^{m} {𝔼 [ {e}^{- {y}_{n} {z}_{s} {f}_{s} ( {\tilde{x}}_{n} )} ]}_{p ( {\tilde{x}}_{n} \vert {x}_{n} )} \qquad ( 9 a )$$

where the independence assumption is used on the corruption across features and source classifiers. Equations (9) and (9)(a) are a product of moment-generating functions [symbol] [e^{t}^{_{nd}}^{\tilde{x}}^{_{nd}}] with t_{nd}=−yₙw_{d} and [symbol] [e^{t}^{ₙₛ}^{f}^{ₛ}^{(x}^{ₙ}⁾] with tₙₛ=−yₙzₛ for linear source classifiers f. The moment-generating function (MGF) can be computed for many corrupting distributions in the natural exponential family. MGFs for the three noise pdfs of Table 1 are given in Table 2.

TABLE 2
Moment-generating functions for selected noise pdfs

| Noise pdf | Moment-generating function (MGF) |
|---|---|
| Blankout noise, unbiased | $\begin{matrix}p ( \tilde{x} = 0 ) = q , p ( \tilde{x} = \frac{x}{1 - q} ) = 1 - q ; \\ with 𝔼 [ {e}^{yw \tilde{x}} ] = q + ( 1 - q ) {e}^{\frac{ywx}{1 - q}}\end{matrix}$ |
| Blankout noise, | p(\tilde{x} = 0) = q, p(\tilde{x} = x) = 1 − q; |
| biased | with [symbol] [\tilde{x}] = q + (1 − q)e^{ywx} |
| Gaussian noise, | p(\tilde{x}\|x) = N(\tilde{x}\|x, σ²), |
| unbiased | with [symbol] [\tilde{x}] = exp(xe^{-yw} − 1) |

Because the expected exponential loss is a convex combination of convex functions, it is convex for any corruption model. The minimization of the exponential loss is suitably performed by using a gradient-descent technique such as an L-BFGS gradient optimizer. See van der Maaten et al., supra.

The marginalization of corrupted features and source classifiers (MCFC) disclosed herein has a little impact on the computational complexity of training step, as the complexity of the training algorithms remains linear in the number of training instances and the source classifiers. The additional training time for minimizing quadratic loss with MCFC is minimal, because the computation time is dominated by the inversion of a D×D matrix. The minimization of the exponential loss is efficient due to the loss convexity and the fast gradient optimizer. Moreover, MCFC makes no assumption on the similarity between source and target classifiers.

In the following, experiments of the disclosed MCFC framework on two datasets are reported. One dataset was ICDA from the ImageClef Domain Adaptation Challenge. The second dataset was the Off10 built on the Office dataset+Caltech10, which is commonly used in the literature for testing domain adaptation techniques.

The ICDA dataset consists of a set of image features extracted on randomly selected images collected from five different image collections: Caltech-256, ImageNet ILSVRC2012, PASCAL VOC2012, Bing, and SUN. Twelve common classes were selected in each dataset, namely, aeroplane, bike, bird, boat, bottle, bus, car, dog, horse, monitor, motorbike, people. Four collections from the list (Caltech, ImageNet, PASCAL and Bing) were used as source domains and for each of them 600 image feature and the corresponding label were provided. The SUN dataset was used as the target domain, with 60 annotated and 600 non-annotated instances. The target domain classifier was trained to provide predictions for the non-annotated target data. Neither the images nor the low level features are available.

The Office+Caltech10 is a dataset provides SURF BOV features. The dataset consists of four domains: Amazon (A), Caltech (C), dslr (D) and Webcam (W) with 10 common classes. Each domain was considered in turn as a target domain, with the other domains being considered as source domains. For the target set three instances per class were selected to form the training set and the remaining data were used as test data. In addition to the provided SUF BOV features, Deep Convolutional Activation Features were used. These features were obtained with the publicly available Caffe (8 layer) CNN model trained on the 1000 classes of ImageNet used in the ILSVRC 2012 challenge.

In the experiments reported here, the last fully connected layer (caffe_fc7) was used as image representation. The dimensionality of these features are 4096.

The first set of experiments were performed with the MCFC framework on ICDA dataset. Four source classifiers [f_{C}, f_{B}, f_{I}, f_{A}] (Caltech, ImageNet, Pascal, Bing) were trained with all available (600) instances from corresponding source domains, for the adaptation in the target domain (SUN). In this experimental setting, they are linear multi-class SVM classifiers, all set to predict label probabilities for the unlabeled target instances. Two cases in the target domain were tested. Case 1, the MCFC was trained with 60 and tested on 600 target instances. The generalization capacity of the MCFC method was then tested in the opposite Case 2, with 600 training and 60 testing instances. The baseline is 69% and 53% classification error for the cases 1 and 2, when no source classifiers are used.

The test noise level q was the same for all features and classifiers and was varied from 0.1 to 0.9. Three MCFC methods were compared to two MCF methods for Cases 1 and 2 as follows: BQ—unbiased blankout quadratic loss with MCF; BQx—unbiased blankout quadratic loss with MCFC; BE—blankout exponential loss with MCF; BEx—blankout exponential loss with MCFC; and bBQx (aka “Our method”)—biased blankout quadratic loss, with MCFC.

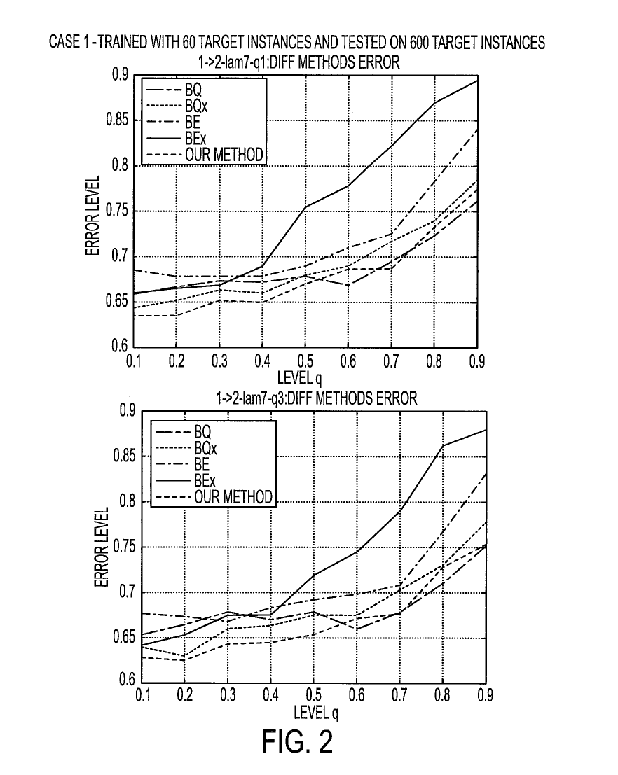

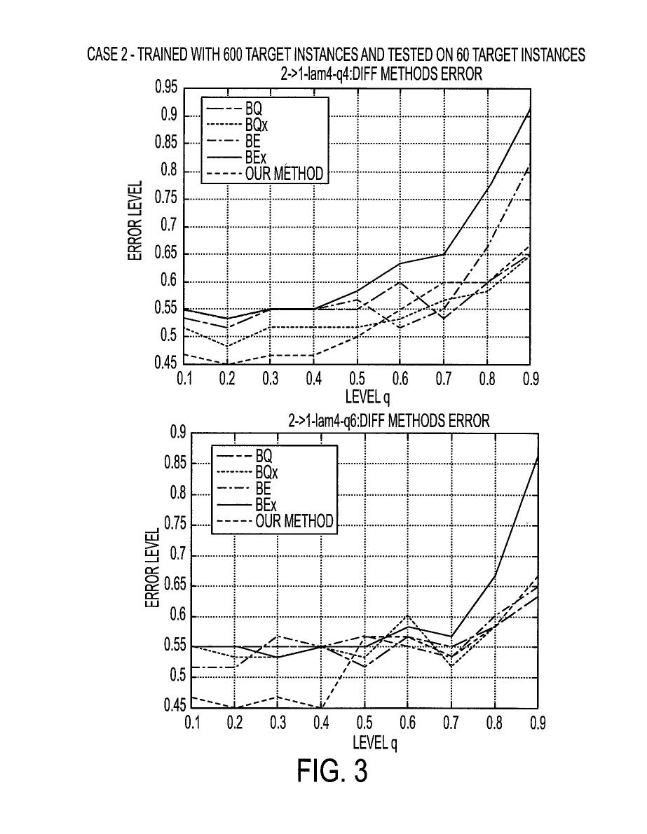

FIG. 2 reports the classification errors of the five methods for Case 1. FIG. 3 reports the classification errors for Case 2. In both cases, all MCFC versions reduce the classification error for small corruption values of q over MCF values. Moreover, the bBQx method is more resistant to more corruption of features and generalizes better than other MCFC versions.

In addition to noise q in the test data, an additional λ parameter was tested, with the regularizer λI (see van der Maaten et al., supra) being added to the numerator and all methods were tested for different values of the parameter λ in the range [0:3].

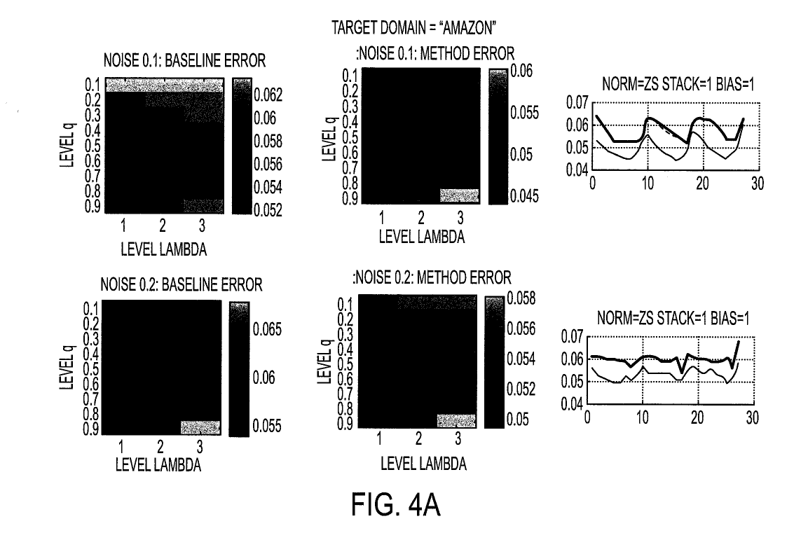

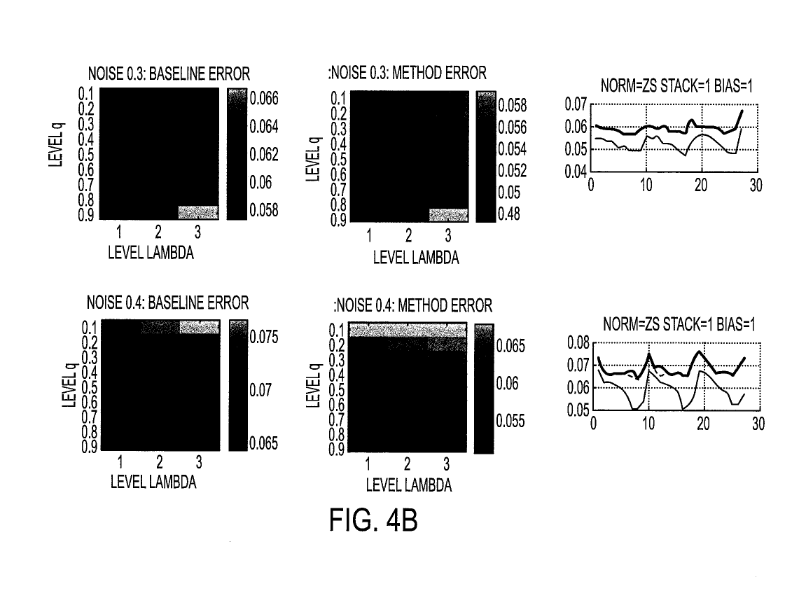

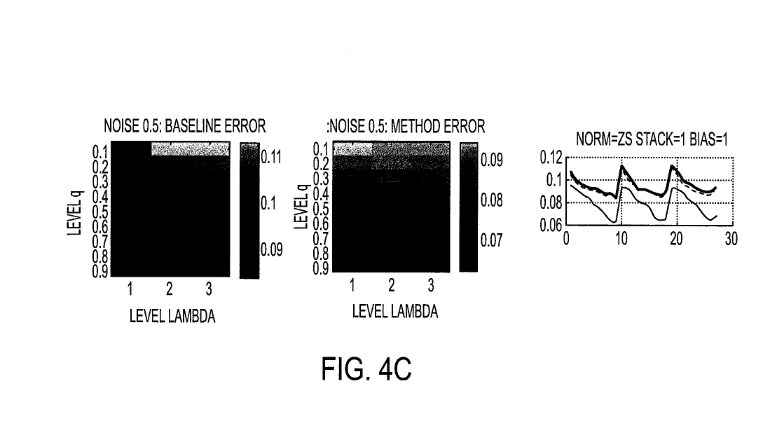

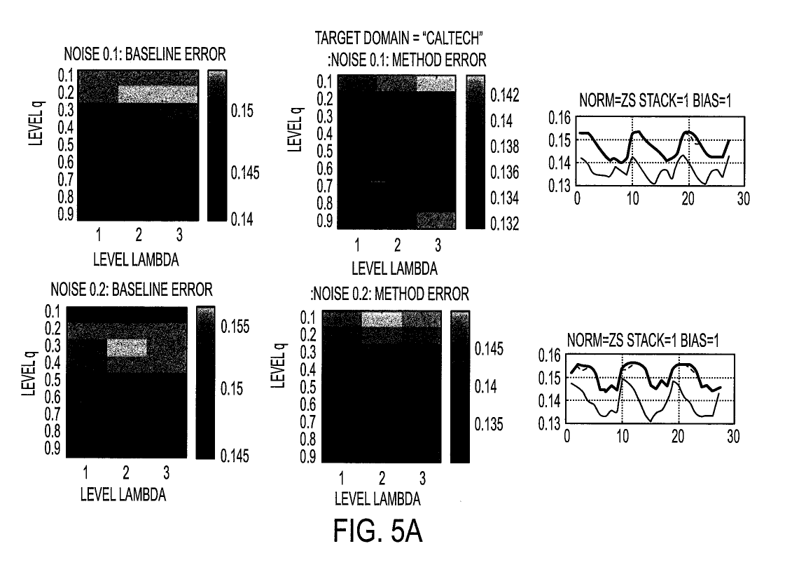

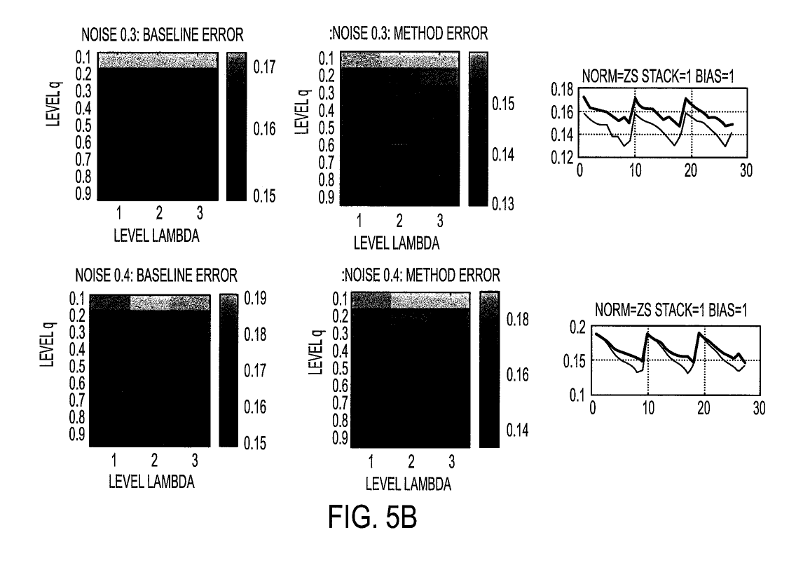

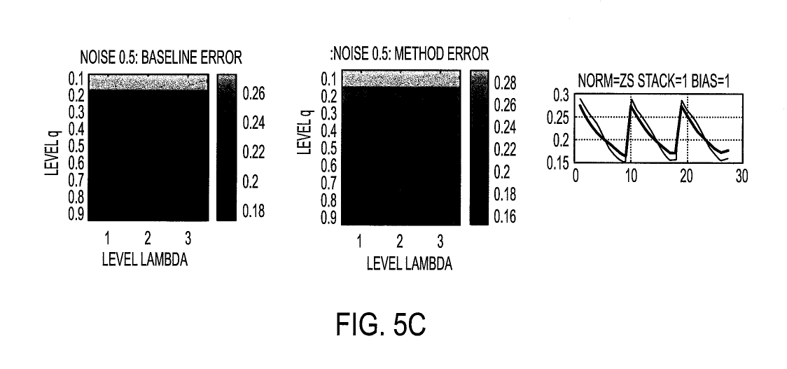

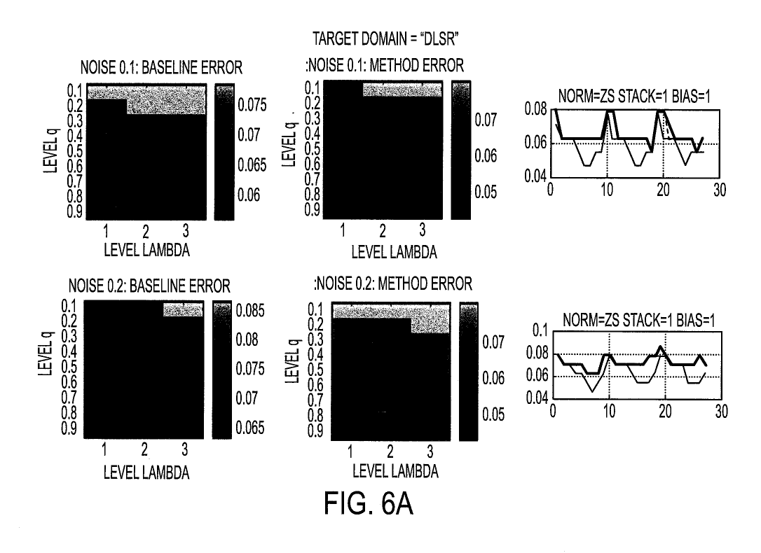

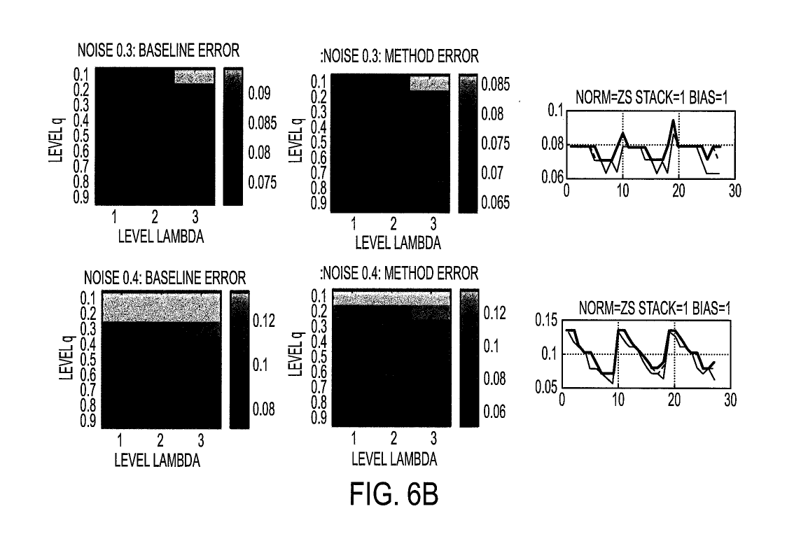

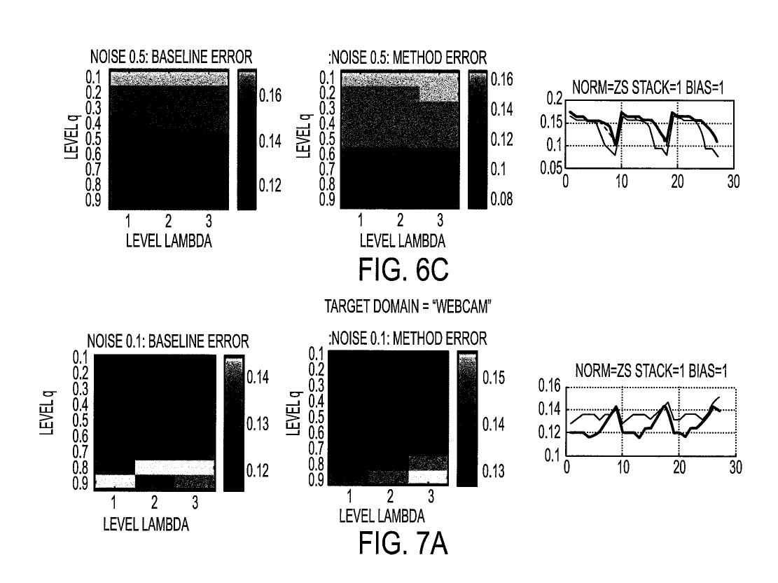

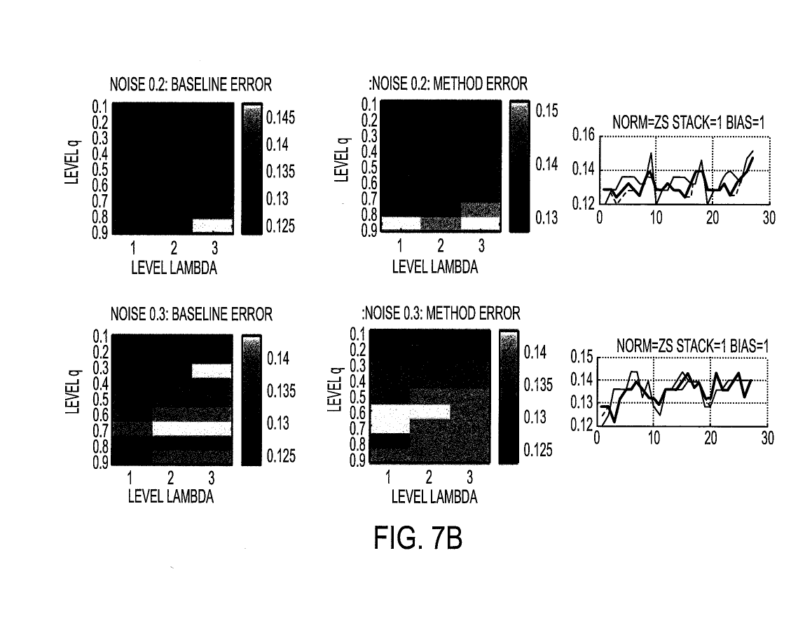

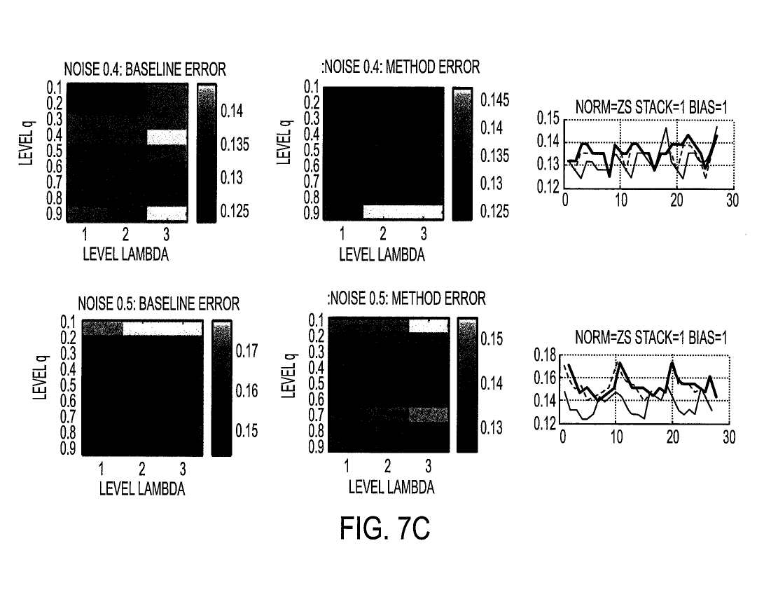

In the second series of evaluations, the MCFC methods were tested for domain adaptation tasks on Off10 dataset. FIGS. 4A, 4B, 4C, 5A, 5B, 5C, 6A, 6B, 6C, 7A, 7B, and 7C compare the classification errors of using MCF and MCFC for four domain adaptation tasks, where Amazon Caltech, DSLR are Webcam are used as target in the results shown in FIGS. 4A, 4B, and 4C; FIGS. 5A, 5B, 5C; FIGS. 6A, 6B, 6C; and FIGS. 7A, 7B, and 7C, respectively. Each of FIGS. 4A, 4B, 4C, 5A, 5B, 5C, 6A, 6B, 6C, 7A, 7B, and 7C compares (the right column) the classification error of three methods (BQ, BQx, and bBQx), where the corruption noise q varies from 0.1 to 0.5 and λ varies between 1 and 3. Two other methods, BE and BEx, perform worse, and they are not included in FIGS. 4A, 4B, 4C, 5A, 5B, 5C, 6A, 6B, 6C, 7A, 7B, and 7C. On most combinations of q and λ, the bBQx method yields the lowest classification errors.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A device comprising:
a computer programmed to perform a machine learning method operating on training instances from a target domain, the training instances represented by feature vectors storing values for a set of features and labeled by labels from a set of labels, the machine learning method including the operations of:
optimizing a loss function dependent on all of:
the feature vectors representing the training instances from the target domain corrupted with noise,
the labels of the training instances from the target domain, and
one or more source domain classifiers operating on the feature vectors representing the training instances from the target domain corrupted with the noise,
to simultaneously learn both a noise marginalizing transform and a weighting of the one or more source domain classifiers; and
generating a label prediction for an unlabeled input instance from the target domain that is represented by an input feature vector storing values for the set of features by operations including applying the learned noise marginalizing transform to the input feature vector and applying the one or more source domain classifiers weighted by the learned weighting to the input feature vector.

2. The device of claim 1 wherein the loss function is not dependent on any training instance from any domain other than the target domain.

3. The device of claim 1 wherein the loss function is a quadratic loss function, the one or more source domain classifiers are linear classifiers, and the optimizing of the quadratic loss function comprises evaluating a closed form solution of the loss function for a vector representing parameters of the noise marginalizing transform and the weighting of the one or more source domain classifiers.

4. The device of claim 3 wherein the closed form solution is dependent upon the statistical expectation and variance values of the training instances from the target domain corrupted with the noise represented by a noise probability density function (noise pdf).

5. The device of claim 1 wherein the loss function is an exponential loss function, the one or more source domain classifiers are linear classifiers, and the optimizing of the exponential loss function is performed analytically using statistical values of the training instances from the target domain corrupted with the noise represented by a noise probability density function (noise pdf).

6. The device of claim 1 wherein the loss function L is optimized by optimizing:
$$ℒ ( w , z ) = {\sum }_{n = 1}^{N} {𝔼 [ L ( {\tilde{x}}_{n} , f , {y}_{n} ; w , z ) ]}_{p ( {\tilde{x}}_{n} \vert {x}_{n} )}$$
where xₙ, n=1, . . . , N are the feature vectors representing the training instances from the target domain, \tilde{x}ₙ, n=1, . . . , N are the feature vectors representing the training instances from the target domain corrupted with the noise, p(\tilde{x}ₙ|xₙ) is a noise probability density function (noise pdf) representing the noise, f represents the one or more source domain classifiers, w represents parameters of the noise marginalizing transform, z represents the weighting of the one or more source domain classifiers, and [symbol] is the statistical expectation.

7. The device of claim 6 wherein generating the label prediction for the unlabeled input instance from the target domain comprises computing the label prediction ŷᵢₙ according to:
ŷᵢₙ=(w*)^{T}xᵢₙ+(z*)^{T}f(xᵢₙ)
where xᵢₙ is the input feature vector representing the unlabeled input instance from the target domain, w* represents the learned parameters of the noise marginalizing transform, and z* represents the learned weighting of the one or more source domain classifiers.

8. The device of claim 1 wherein the loss function L is a quadratic loss function and the optimizing of the quadratic loss function L comprises minimizing:
$$ℒ ( w , z ) = \frac{1}{N} {\sum }_{n = 1}^{N} {𝔼 [ {( {w}^{T} {\tilde{x}}_{n} + {z}^{T} f ( {\tilde{x}}_{n} ) - {y}_{n} )}^{2} ]}_{p ( {\tilde{x}}_{n} \vert {x}_{n} )}$$
where xₙ, n=1, . . . , N are the feature vectors representing the training instances from the target domain, \tilde{x}ₙ, n=1, . . . , N are the feature vectors representing the training instances from the target domain corrupted with the noise, p(\tilde{x}ₙ|xₙ) is a noise probability density function (noise pdf) representing the noise, f represents the one or more source domain classifiers, w represents parameters of the noise marginalizing transform, z represents the weighting of the one or more source domain classifiers, and [symbol] is the statistical expectation.

9. The device of claim 8 wherein the one or more source domain classifiers f are linear classifiers, and the minimizing comprises evaluating a closed form solution of [symbol] (w,z) for a vector
$$[ \begin{matrix}{w}^{*} \\ {z}^{*}\end{matrix} ]$$
where w* represents the learned parameters of the noise marginalizing transform and z* represents the learned weighting of the one or more source domain classifiers.

10. The device of claim 1 wherein the loss function L is an exponential loss function and the optimizing of the exponential loss function L comprises minimizing:
$$ℒ ( w , z ) = {\sum }_{n = 1}^{N} {𝔼 [ {e}^{- {y}_{n} ( {w}^{T} {\tilde{x}}_{n} + {z}^{T} f ( {\tilde{x}}_{n} ) )} ]}_{p ( {\tilde{x}}_{n} \vert {x}_{n} )}$$
where xₙ, n=1, . . . , N are the feature vectors representing the training instances from the target domain, \tilde{x}ₙ, n=1, . . . , N are the feature vectors representing the training instances from the target domain corrupted with the noise, p(\tilde{x}ₙ|xₙ) is a noise probability density function (noise pdf) representing the noise, f represents the one or more source domain classifiers, w represents parameters of the noise marginalizing transform, z represents the weighting of the one or more source domain classifiers, and [symbol] is the statistical expectation.

11. The device of claim 1 wherein one of:
each training instance from the target domain represents a corresponding image, the set of features is a set of image features, the one or more source domain classifiers are one or more source domain image classifiers, and the machine learning method includes the further operation of generating each training instance from the target domain by extracting values for the set of image features from the corresponding image; and
each training instance from the target domain represents a corresponding text-based document, the set of features is a set of text features, the one or more source domain classifiers are one or more source domain document classifiers, and the machine learning method includes the further operation of generating each training instance from the target domain by extracting values for the set of text features from the corresponding text-based document.

12. A non-transitory storage medium storing instructions executable by a computer to perform a machine learning method operating on N training instances from a target domain, the training instances represented by feature vectors xₙ, n=1, . . . , N storing values for a set of features and labeled by labels yₙ, n=1, . . . , N from a set of labels, the machine learning method including the operations of:
optimizing the function [symbol] (w,z) given by:
$$ℒ ( w , z ) = {\sum }_{n = 1}^{N} {𝔼 [ L ( {\tilde{x}}_{n} , f , {y}_{n} ; w , z ) ]}_{p ( {\tilde{x}}_{n} \vert {x}_{n} )}$$
with respect to w and z where \tilde{x}ₙ, n=1, . . . , N are the feature vectors representing the training instances from the target domain corrupted with noise, p(\tilde{x}ₙ|xₙ) is a noise probability density function (noise pdf) representing the noise, f represents one or more source domain classifiers, L is a loss function, w represents parameters of a noise marginalizing transform, z represents a weighting of the one or more source domain classifiers, and [symbol] is the statistical expectation, to generate learned parameters w* of the noise marginalizing transform and a learned weighting z* of the one or more source domain classifiers; and
generating a label prediction ŷᵢₙ for an unlabeled input instance from the target domain represented by input feature vector xᵢₙ by operations including applying the noise marginalizing transform with the learned parameters w* to the input feature vector xᵢₙ and applying the one or more source domain classifiers weighted by the learned weighting z* to the input feature vector xᵢₙ.

13. The non-transitory storage medium of claim 12 wherein the loss function L is the quadratic loss function (w^{T}\tilde{x}ᵢₙ+z^{T}f(\tilde{x}ₙ)−yₙ)².

14. The non-transitory storage medium of claim 12 wherein the loss function L is a quadratic loss function, the one or more source domain classifiers f are linear classifiers, and the optimizing comprises evaluating a closed form solution of [symbol] (w,z) for a vector
$$[ \begin{matrix}{w}^{*} \\ {z}^{*}\end{matrix} ]$$
where w* represents the learned parameters of the noise marginalizing transform and z* represents the learned weighting of the one or more source domain classifiers.

15. The non-transitory storage medium of claim 12 wherein the loss function L is the exponential loss function e^{-y}^{ₙ}^{(w}^{^{T}}^{\tilde{x}}^{ₙ}^{+z}^{^{T}}^{f(\tilde{x}}^{ₙ}⁾).

16. The non-transitory storage medium of claim 12 wherein each training instance from the target domain represents a corresponding image, the set of features is a set of image features, the one or more source domain classifiers are one or more source domain image classifiers, and the machine learning method includes the further operation of:
generating the feature vector xₙ representing each training instance by extracting values for the set of image features from the corresponding image.

17. The non-transitory storage medium of claim 12 wherein each training instance from the target domain represents a corresponding text-based document, the set of features is a set of text features, the one or more source domain classifiers are one or more source domain document classifiers, and the machine learning method includes the further operation of:
generating the feature vector xₙ representing each training instance by extracting values for the set of text features from the corresponding text-based document.

18. A machine learning method operating on training instances from a target domain, the training instances represented by feature vectors storing values for a set of features and labeled by labels from a set of labels, the machine learning method comprising:
simultaneously learning both a noise marginalizing transform and a weighting of one or more source domain classifiers by minimizing the expectation of a loss function dependent on the feature vectors corrupted with noise represented by a noise probability density function, the labels, and the one or more source domain classifiers operating on the feature vectors corrupted with the noise; and
labeling an unlabeled input instance from the target domain with a label from the set of labels by operations including applying the learned noise marginalizing transform to an input feature vector representing the unlabeled input instance and applying the one or more source domain classifiers weighted by the learned weighting to the input feature vector representing the unlabeled input instance;
wherein the simultaneous learning and the labeling are performed by a computer.

19. The method of claim 18 wherein the loss function is not dependent on any feature vector representing a training instance from any domain other than the target domain.

20. The method of claim 18 wherein the loss function is a quadratic loss function and the simultaneous learning comprises evaluating a closed form solution of the loss function for a vector representing parameters of the noise marginalizing transform and the weighting of the one or more source domain classifiers.
